(19) United States
(12) Patent Application Publication
(10) Pub. No.: US 2026/0245926 A1
(43) Pub. Date: Aug. 20, 2026

(54) Fuel Gas Supply Device

(71) Applicant: HONDA MOTOR CO., LTD., TOKYO (JP)

(72) Inventors: Zixuan QIN, WAKO-SHI (JP); Naohiro YOSHIOKA, WAKO-SHI (JP)

(21) Appl. No.: 19/539,157

(22) Filed: Feb. 13, 2026

(30) Foreign Application Priority Data
Feb. 18, 2025 (JP) 2025-024166

(51) Int. Cl. H01M 8/04089; F02M 55/02; H01M 8/04082; H01M 8/04746; H01M 8/2457; H01M 8/2484

(52) U.S. Cl. CPC H01M 8/04097; F02M 55/025; H01M 8/04201; H01M 8/04753; H01M 8/2457; H01M 8/2484

(57) ABSTRACT

A fuel gas supply device includes a high-pressure pipe through which the high-pressure fuel gas flows, a first injector unit in communication with the high-pressure pipe, the first injector unit being configured to jet out the high-pressure fuel gas at a first flow rate, a first ejector configured to feed an off gas to the fuel cell using a jet flow from the first injector unit, a second injector unit in communication with the high-pressure pipe, the second injector unit being configured to jet out the high-pressure fuel gas at a second flow rate higher than the first flow rate, and a second ejector configured to feed the off gas to the fuel cell using a jet flow from the second injector unit, wherein the second ejector is disposed at a position closer to a first axis extending along a center of the high-pressure pipe than the first ejector.

### CROSS-REFERENCE TO RELATED APPLICATIONS

This application is based upon and claims the benefit of priority from Japanese Patent Application No. 2025-024166 filed on February 18, 2025, the contents of which are incorporated herein by reference.

### BACKGROUND OF THE INVENTION

### Field of the Invention

The present disclosure relates to a fuel gas supply device that supplies a fuel gas to a fuel cell.

### Description of the Related Art

In recent years, research and development have been conducted on fuel cells that contribute to energy efficiency in order to ensure that more people have access to affordable, reliable, sustainable and modern energy (for example, JP 5594162 B2).

### SUMMARY OF THE INVENTION

In the art related to fuel cells, it is a challenge to achieve both high output, compactness, and improved durability.

The present disclosure has been made to solve the above problems, and an object of the present disclosure is to achieve a compact structure and durability against vibration of a fuel gas supply device to which a plurality of injectors are mounted to increase the output. The present invention thus contributes to energy efficiency.

A first aspect of the present disclosure is characterized by a fuel gas supply device configured to supply a high-pressure fuel gas to a fuel cell, the fuel gas supply device including a high-pressure pipe through which the high-pressure fuel gas flows, a first injector unit in communication with the high-pressure pipe, the first injector unit being configured to jet out the high-pressure fuel gas at a first flow rate, a first ejector configured to feed an off gas to the fuel cell using a jet flow from the first injector unit, a second injector unit in communication with the high-pressure pipe, the second injector unit being configured to jet out the high-pressure fuel gas at a second flow rate higher than the first flow rate, and a second ejector configured to feed the off gas to the fuel cell using a jet flow from the second injector unit, wherein the second ejector is disposed at a position closer to a first axis extending along a center of the high-pressure pipe than the first ejector.

A second aspect of the present disclosure is characterized by a fuel gas supply device configured to supply a high-pressure fuel gas to a fuel cell, the fuel gas supply device including: a first injector unit configured to jet out a high-pressure fuel gas at a first flow rate; a first ejector configured to feed an off gas to the fuel cell using a jet flow from the first injector unit; a second injector unit configured to jet out the high-pressure fuel gas at a second flow rate higher than the first flow rate; a second ejector configured to feed the off gas to the fuel cell again using a jet flow from the second injector unit; and a merging portion connected to a downstream side of the first ejector and the second ejector, wherein the merging portion includes a first opening into which a jet flow from the first ejector flows, a second opening into which a jet flow from the second ejector flows, a merging path extending to encompass an extending direction of the first ejector and an extending direction of the second ejector and to allow the fuel gas from the first opening and the fuel gas from the second opening to be merged, and a bent portion provided downstream of the merging path and bent toward the fuel cell, the first opening being disposed closer to an inner radius of the bent portion, the second opening being disposed closer to an outer radius of the bent portion.

The fuel gas supply device of the present disclosure contributes to an increase in output of the fuel cell, an improvement in durability, and a reduction in size.

The above and other objects, features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a configuration diagram of a fuel gas supply system of a fuel cell system according to the present embodiment;

FIG. 2 is a plan view of the fuel gas supply device according to the present embodiment in a state of being attached to a stack case of a fuel cell;

FIG. 3 is a schematic cross-sectional view of the fuel gas supply device shown in FIG. 2;

FIG. 4 is an explanatory view of an arrangement relationship of flow paths of the fuel gas supply device shown in FIG. 2, with first and second injectors omitted from illustration; and

FIG. 5 is an exploded perspective view illustrating connection structure of injectors to first and second ejectors.

### DETAILED DESCRIPTION OF THE INVENTION

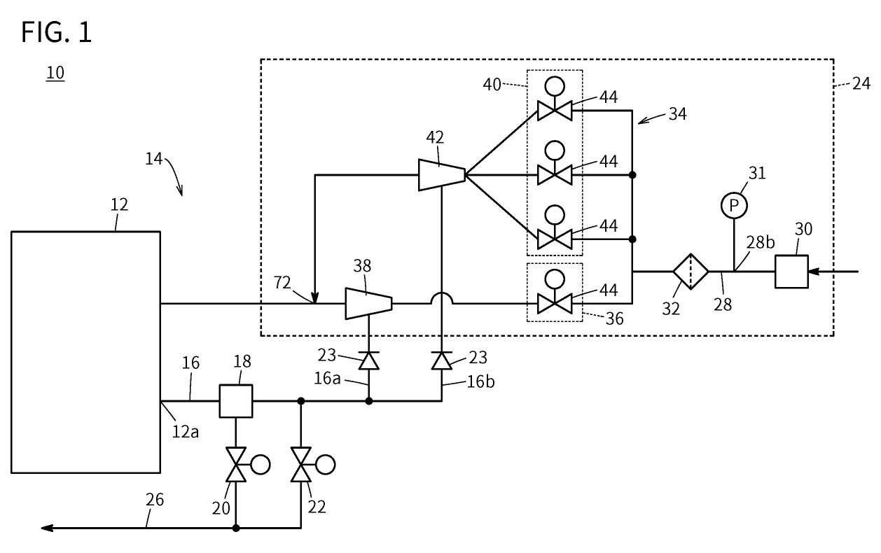

As shown in FIG. 1, a fuel cell system 10 according to the present embodiment includes a fuel gas supply system 14 that supplies hydrogen gas as a fuel gas to an anode of a fuel cell 12 (also referred to as a fuel cell stack). The fuel gas supply system 14 has a fuel gas circulation path 16 for supplying the fuel gas discharged from the fuel cell 12 (off-gas) to the fuel cell 12 again.

The circulation path 16 is provided with a gas-liquid separator 18, a purge value 22, check valves 23, and a fuel gas supply device 24 in this order from the anode outlet 12a of the fuel cell 12. The gas-liquid separator 18 separates water in a liquid phase contained in the off-gas. The gas-liquid separator 18 is provided with a drain valve 20. The drain valve 20 is opened at a predetermined timing, so that the water collected in the gas-liquid separator 18 is discharged to an exhaust flow path 26. The purge valve 22 is opened to discharge the off-gas to the exhaust flow path 26 when a concentration of impurity gas increases, when a pressure in the circulation path 16 increases, or the like.

The circulation path 16 branches upstream of the fuel gas supply device 24 into a low flow path 16a and a high flow path 16b. The check valves 23 are attached to the low flow path 16a and the high flow path 16b, respectively. The low flow path 16a is connected to a first ejector 38, and serves as a path through which the off-gas flows in the case where the fuel cell 12 operates at a low output.

The high flow path 16b is connected to a second ejector 42, and serves as a path through which the off-gas flows in addition to the low flow path 16a in the case where the fuel cell 12 operates at a high output. The check valves 23 prevent propagation of the negative pressure between the first ejector 38 and the second ejector 42, and prevents interference of the operations between the first ejector 38 and the second ejector 42. In one non-limiting aspect, the low flow path 16a, the high flow path 16b, and the check valves 23 may be included in the fuel gas supply device 24.

The fuel gas supply device 24 includes a high-pressure pipe 28, a shut-off valve 30, a pressure sensor 31, a filter 32, a branching portion 34, a first injector unit 36, the first ejector 38, a second injector unit 40, and the second ejector 42. The high-pressure pipe 28 is connected to a gas tank that stores the high-pressure fuel gas. For example, a high-pressure hydrogen gas having a pressure of several to several tens MPa flows through the high-pressure pipe 28.

The high-pressure pipe 28 is provided with the shut-off valve 30, the pressure sensor 31, and the filter 32. The shut-off valve 30 shuts off supply of the fuel gas to the circulation path 16 while operation of the fuel cell 12 is suspended or the like. The pressure sensor 31 is connected to the high-pressure pipe 28 through a sensor hole section 28b. The pressure sensor 31 detects the internal pressure in the high-pressure pipe 28. The filter 32 is disposed downstream of the shut-off valve 30 and the pressure sensor 31, and removes foreign matter from the high-pressure fuel gas.

The branching portion 34 is a flow path member attached to the downstream side of the high-pressure pipe 28. The branching portion 34 guides the high-pressure fuel gas to the first injector unit 36 and the second injector unit 40 through a plurality of branched flow paths (described later). The first injector unit 36 includes one injector 44 and can discharge the high-pressure fuel gas at a first flow rate toward the first ejector 38. In the case where the fuel cell 12 is operated at the low output, the first injector unit 36 and the first ejector 38 are allowed to cause supply of a fresh fuel gas and circulation of the off-gas (fuel gas) through the circulation path 16.

The second injector unit 40 includes a plurality of (for example, three) injectors 44. The second injector unit 40 can discharge the high-pressure fuel gas toward the second ejector 42 at a second flow rate higher than the first flow rate. In the case where the fuel cell 12 is operated at the high output, the second injector unit 40 and the second ejector 42 are allowed to cause supply of a fresh fuel gas and circulation of the off-gas through the circulation path 16.

The configuration of the fuel gas supply device 24 will be described in more detail below.

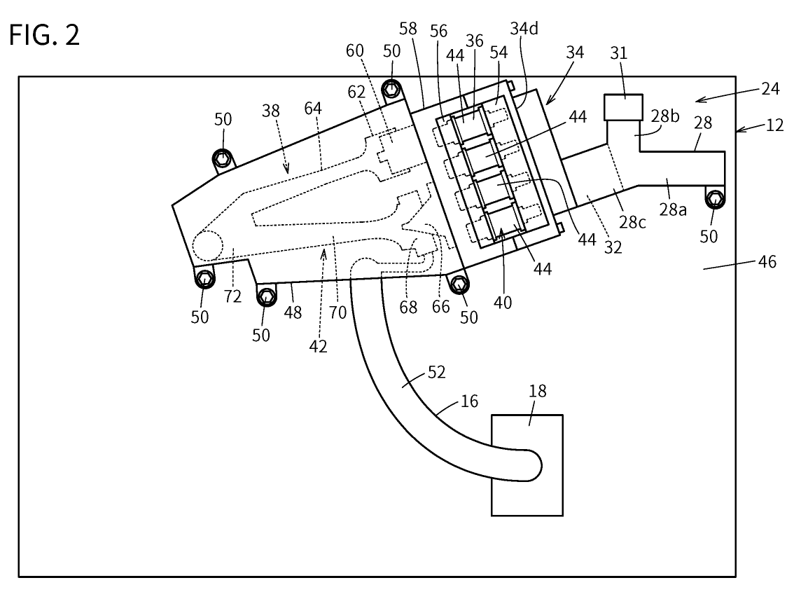

As shown in FIG. 2, the fuel gas supply device 24 is disposed, for example, on a side portion of a stack case 46 of the fuel cell 12. The fuel gas supply device 24 includes an ejector housing 48 that houses the first ejector 38 and the second ejector 42, and the ejector housing 48 and the high-pressure pipe 28 are fixed to the stack case 46 through fastening members 50 such as bolts. A second pipe 52, which constitutes a part of the circulation path 16 extending from the gas-liquid separator 18, is connected to a lower portion of the ejector housing 48.

The second pipe 52, which also constitutes yet another part of the circulation path 16, extends from the distal end side of the ejector housing 48 into the interior of the stack case 46 of the fuel cell 12. The first injector unit 36 and the second injector unit 40 are connected to the base end side of the ejector housing 48. The first injector unit 36 and the second injector unit 40 are supported by being sandwiched between a first plate 34d and a second plate 58, and joined to the ejector housing 48 via the second plate 58.

The high-pressure pipe 28 is connected to the base end side of the first injector unit 36 and the second injector unit 40 via the first plate 34d. The horizontally extending portion of the high-pressure pipe 28 is fixed to the stack case 46 by the fastening member 50 such as a bolt. Since the first plate 34d and the second plate 58 supporting the first injector unit 36 and the second injector unit 40 are not fixed to the stack case 46, the reactive forces at the time of injections of the first injector unit 36 and the second injector unit 40 are received mainly by the high-pressure pipe 28 fixed to the stack case 46.

The high-pressure pipe 28 includes a straight section 28a extending horizontally and linearly, the sensor hole section 28b, and a downstream end 28c. The straight section 28a is fixed to the stack case 46 by the fastening member 50. The straight section 28a serves as a fulcrum that receives vibration due to the injections of the first injector unit 36 and the second injector unit 40. The central axis of the straight section 28a is referred to herein as the first axis.

The sensor hole section 28b branches off and extends upward from the straight section 28a. A pressure sensor 31 is attached to the sensor hole section 28b. The downstream end 28c angles downward to extend obliquely from the straight portion 28a near the sensor hole section 28b. Therefore, the downstream end 28c is inclined with respect to the first axis. The downstream end 28c is connected to the branching portion 34. The filter 32 is disposed at the downstream end 28c and is held by being sandwiched between the branching portion 34 and the sensor hole section 28b.

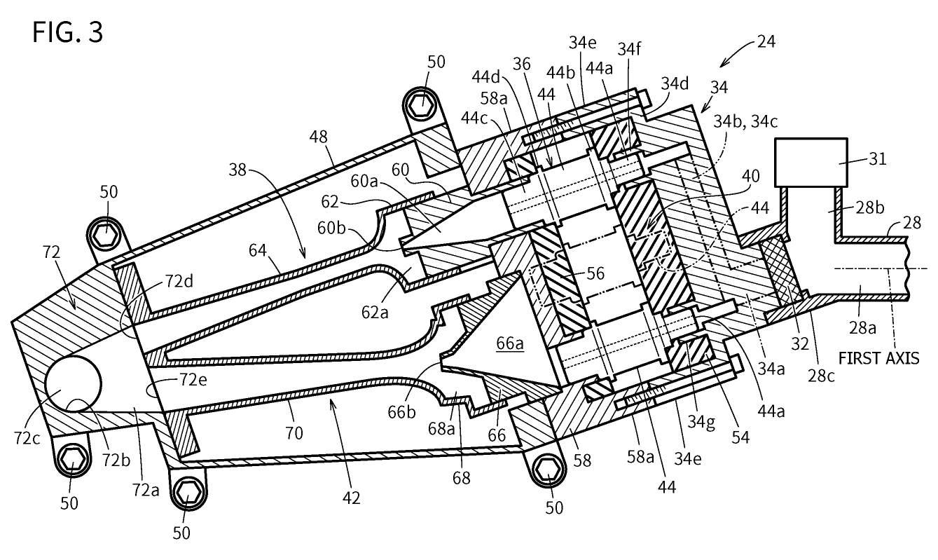

As shown in FIG. 3, the branching portion 34 is formed integrally with the first plate 34d. The first plate 34d has a main surface perpendicular to the extending direction of the downstream end 28c, and supports the base end sides of the first injector unit 36 and the second injector unit 40. The first plate 34d includes a plurality of first pillar portions 34e extending at a peripheral edge portion thereof toward the distal end. The first pillar portions 34e have screw structure allowing fastening members such as bolts to pass therethrough, and are connected to the second pillar portions 58a extending from the second plate 58.

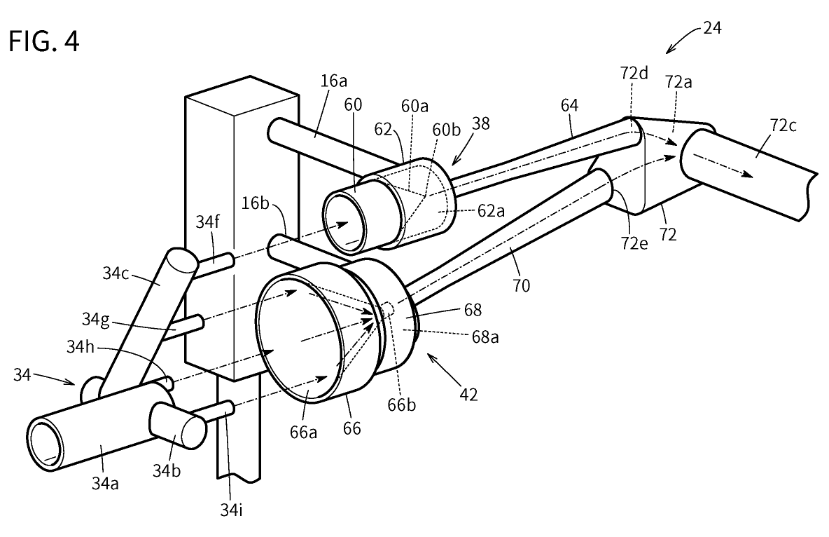

As illustrated in FIG. 4, the branching portion 34 includes a first flow path section 34a, a second flow path section 34b, a third flow path section 34c, a first connection section 34f, a second connection section 34g, a third connection section 34h, and a fourth connection portion 34i. The first flow path section 34a extends toward the base end side perpendicularly to the first plate 34d, and is connected to the downstream end 28c. The first flow path section 34a extends linearly coaxially with the downstream end 28c.

The second flow path section 34b and the third flow path section 34c extend in directions parallel to the main surface of the first plate 34d and are formed so as to have a thickness in a direction toward the base end side of the first plate 34d (see FIG. 3). The second flow path section 34b extends from the first flow path section 34a in a direction orthogonal to the first flow path section 34a. The central axis of the second flow path section 34b extends in a substantially horizontal direction. The third flow path section 34c intersects the second flow path section 34b and extends obliquely upward. The central axis of the third flow path section 34c extends at an angle of 60° to the central axis of the second flow path section 34b.

The first connection section 34f, the second connection section 34g, the third connection section 34h, and the fourth connection section 34i have flow paths that penetrate the first plate 34d in the thickness direction and extend toward the second plate 58. These flow paths communicate with the second flow path section 34b or the third flow path section 34c. The inner diameters of the flow paths of the first connection section 34f, the second connection section 34g, the third connection section 34h, and the fourth connection section 34i have dimensions capable of accommodating an inlet member 44a of the injector 44. A portion of each of the first connection section 34f, the second connection section 34g, the third connection section 34h, and the fourth connection section 34i extends short in a tubular shape toward the distal end side of the first plate 34d.

The first connection section 34f is connected to the injector 44 of the first injector unit 36. The second connection section 34g, the third connection section 34h, and the fourth connection section 34i are respectively connected to the injectors 44 of the second injector unit 40.

The first connection section 34f, the second connection section 34g, and the third connection section 34h are arranged linearly along the third flow path section 34c. The first connection section 34f is disposed near the end of the third flow path section 34c that is farthest from the first flow path section 34a. Therefore, the first connection section 34f is located at a portion farthest from the first axis of the high-pressure pipe 28.

The second connection section 34g is disposed adjacent to the first connection section 34f. The third connection section 34h is provided at or near the intersection of the third flow path section 34c and the second flow path section 34b. In this way, by arranging the first connection section 34f, the second connection section 34g, and the third connection section 34h in parallel along a straight line, the shape of the third flow path section 34c can be made straight, and the manufacturing process can be simplified.

The fourth connection section 34i extends from the second flow path section 34b. The fourth connection section 34i may be disposed coaxially with the first flow path section 34a. The second connection section 34g, the third connection section 34h, and the fourth connection section 34i are disposed at positions closer to the first axis of the high-pressure pipe 28 than the first connection section 34f, and are connected to the high-pressure pipe 28 by a path shorter than the first connection section 34f. Thus, the injectors 44 of the second injector unit 40 are connected to the high-pressure pipe 28 through shorter paths than the path through which the injector 44 of the first injector unit 36 is connected to the high-pressure pipe 28.

Further, the second connection section 34g, the third connection section 34h, and the fourth connection section 34i are arranged in a positional relationship of being vertexes of an equilateral triangle on the main surface of the first plate 34d. Such a highly symmetrical arrangement can suppress variations in the injection characteristics of the three injectors 44 included in the second injector unit 40. The two injectors 44 of the second injector unit 40 and the injector 44 of the first injector unit 36 are arranged in parallel along a straight line. All the injectors 44 are arranged in alignment on the same plane.

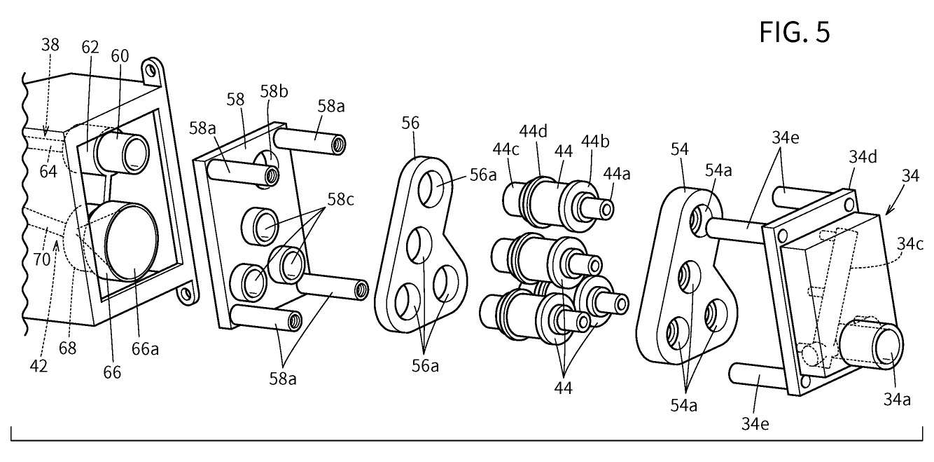

As shown in FIG. 5, the injector 44 includes the inlet member 44a, a base end step 44b, an outlet member 44c, and a distal end step 44d. The injector 44 used for the first injector unit 36 and the injectors 44 used for the second injector unit 40 are the same components and have the same structure.

The first connection section 34f, the second connection section 34g, the third connection section 34h, and the fourth connection section 34i shown in FIGS. 3 and 4 respectively receive the inlet members 44a in a manner so that the inlet members 44a are displaceable in the axial direction in the state of being inserted thereinto. The inlet members 44a are restricted from being displaced in the radial direction by the first connection section 34f, the second connection section 34g, the third connection section 34h, and the fourth connection section 34i. A packing member (not shown) is attached to the outer peripheries of the inlet members 44a to seal gaps between any of the inlet members 44a and the first connection section 34f, the second connection section 34g, the third connection section 34h, or the fourth connection section 34i.

A first damping plate 54 is attached to the base end steps 44b. As shown in FIG. 5, the first damping plate 54 is a plate-shaped member made of an elastic member and having a plurality of first holes 54a through which the inlet members 44a can be inserted. The surface of the first damping plate 54 on the base end side is joined to the first plate 34d. The first damping plate 54 abuts against the base end steps 44b as shown in FIG. 3, thereby restricting the displacement of the injectors 44 in the base end direction. The injectors 44 are supported by the first plate 34d via the first damping plate 54. The first damping plate 54 integrating the plurality of injectors 44 can disperse vibrations generated in individual injectors 44 over a wide area, while preventing occurrence of resonance.

The distal ends of the injectors 44 are supported by the second damping plate 56 and the second plate 58. The second plate 58 is a plate-shaped member having a planar shape similar to the planar shape of the first plate 34d. A plurality of second pillar portions 58a extending toward the first plate 34d are formed at predetermined positions of the peripheral edge portion of the second plate 58. The second pillar portions 58a are connected to the first pillar portions 34e of the first plate 34d.

The second plate 58 is provided with a through hole 58b and three connection tubes 58c. The through hole 58b penetrates the second plate 58. The through hole 58b is located on an extension line of the first connection section 34f, and receives the outlet member 44c of the injector 44 connected to the first connecting section 34f. The base end of a first nozzle 60 of the first ejector 38 is inserted into the through hole 58b.

As shown in FIG. 3, the outlet member 44c of the injector 44 of the first injector unit 36 is inserted into the first nozzle 60. The outlet member 44c of the injector 44 is inserted into the first nozzle 60 so as to be displaceable in the direction of an injector axis. A gap between the inner circumferential surface of the first nozzle 60 and the outer circumferential surface of the outlet member 44c is sealed by packing or the like.

As shown in FIGS. 3 and 5, the connection tubes 58c of the second plate 58 are tubular portions extending toward the base end side. A flow path communicating with a second nozzle 66 of the second ejector 42 is formed inside the connection tubes 58c. The outlet members 44c of the injectors 44 of the second injector unit 40 are inserted into the connection tubes 58c. The connection tubes 58c accommodate the outlet members 44c so as to be displaceable in the axial directions of the injectors 44. Gaps between the inner peripheral surfaces of the connection tubes 58c and the outer peripheral surfaces of the outlet members 44c are sealed by packing or the like.

The second damping plate 56 shown in FIGS. 3 and 5 is a plate-shaped member made of an elastic member, and having four second holes 56a through which the outlet members 44c of the four injectors 44 can be inserted. The distal end surface of the second damping plate 56 is joined to the second plate 58. The second damping plate 56 is disposed between the second plate 58 and the distal end steps 44d of the injectors 44, and restricts displacement of the injectors 44 toward the distal end side. The second damping plate 56 attenuates vibrations due to injections of the injectors 44. The second damping plate 56 integrating the plurality of injectors 44 can disperse vibrations generated in individual injectors 44 over a wide area, while preventing occurrence of resonance.

The first ejector 38 and the second ejector 42 are connected to the distal end side of the second plate 58. The first ejector 38 includes the first nozzle 60, a first main body 62, and a first diffuser 64. The first nozzle 60 is attached to the second plate 58 and is disposed downstream of the first injector unit 36. The first nozzle 60 is connected to the injector 44 of the first injector unit 36. The high-pressure fuel gas jetted from one of the injectors 44 at the first flow rate is jetted to the first ejector 38 through the first nozzle 60. The first nozzle 60 has a restrictor 60a that is tapered toward the tip end. An orifice 60b is formed at the tip of the restrictor 60a. The central axes of the restrictor 60a and the orifice 60b are aligned coaxially with the injector axis of the first injector unit 36.

The orifice 60b is open to the first main body 62. The circulation path 16 is connected to a side of the first main body 62. The first nozzle 60 protrudes into the first main body 62. The first diffuser 64 is disposed on the distal end of the first nozzle 60. The first main body 62 forms a first annular passage 62a between the first nozzle 60 and the first diffuser 64. One end of the circulation path 16 is open to the first annular passage 62a. The first diffuser 64 is formed in a shape having an inner diameter gradually increasing toward the downstream side. The central axis of the first diffuser 64 is the center of the jet flow from the first ejector 38 and is a first jetting axis. The first jetting axis is coaxially aligned with the central axis of the first nozzle 60 and the injector axis of the first injector unit 36.

The second ejector 42 includes the second nozzle 66, a second main body 68, and a second diffuser 70. The second nozzle 66 is disposed downstream of the three injectors 44 and is attached to the distal end side of the second plate 58. The second nozzle 66 has a conical flow passage 66a formed in a conical shape so as to merge the high-pressure fuel gas jetted from the plurality of injectors 44. The conical flow passage 66a is tapered in a direction away from the second injector unit 40.

The conical flow passage 66a has the largest internal diameter at the base end to accommodate the outlet members 44c of the three injectors 44. The high-pressure fuel gas from the three injectors 44 at the second flow rate is jetted to the second ejector 42 through the second nozzle 66.

A second axis extending along the center of the conical flow passage 66a is parallel to the axial direction of the injectors 44 included in the second injector unit 40. The central axis of the conical flow passage 66a is equidistant to the three injectors 44, and the three injectors 44 are arranged at equal intervals (120°) in the circumferential direction with the central axis extending the central position thereof. In this layout, difference in injection capacity among injectors can be reduced when the injectors 44 are individually operated. Therefore, the second nozzle 66 enables rotation operation while sequentially stopping some of the injectors 44, and contributes to the extension of the life of the second injector unit 40.

The second nozzle 66 further includes a spout 66b communicating with the tip of the conical flow passage 66a. The spout 66b extends obliquely with respect to the second axis of the conical flow passage 66a. The high-pressure gas is jetted from the spout 66b toward the second diffuser 70. The extending direction of the spout 66b coincides with a second jetting axis of the second diffuser 70.

The second main body 68 forms a second annular passage 68a between the second nozzle 66 and the second diffuser 70. One end of the circulation path 16 is open to the second annular passage 68a. The second diffuser 70 increases its inner diameter gradually toward the downstream side. The second diffuser 70 has an average flow path cross-sectional area larger than an average flow path cross-sectional area of the first diffuser 64, and can efficiently cause the fuel gas in the circulation path 16 to flow with respect to a larger jet flow of the high-pressure fuel gas.

The first ejector 38 and the second ejector 42 generate reaction forces in the axial directions thereof in accordance with injection of the high-pressure fuel gas. The second ejector 42 has a larger flow rate and a higher flow velocity than the first ejector 38, and thus generates larger reaction forces. These reaction forces are transmitted to the respective parts of the fuel gas supply device 24 as vibrations, and may loosen the bolts that fasten the fuel gas supply device 24 to the stack case 46, for example, which may increase the frequency of maintenance and reduce durability.

In view of the above, in the fuel gas supply device 24 of the present embodiment, an angle between the second jetting axis of the second ejector 42 and a first axis of the high-pressure pipe 28 is set to be smaller than an angle between the first jetting axis of the first ejector 38 and the first axis of the high-pressure pipe 28. Accordingly, the reaction force of the second ejector 42 can be effectively received by the high-pressure pipe 28 having high strength, and the occurrence of vibration is suppressed.

Further, the second ejector 42 is disposed at a position closer to the extension line of the first axis of the high-pressure pipe 28 than the first ejector 38, and is connected to the second plate 58 at a position closer to the first axis. This reduces the torque generated by the reaction force of the second ejector 42, which generates a larger reaction force, and thus more effectively reduces the vibration of the fuel gas supply device 24.

The second injector unit 40 and the second ejector 42, which are large and heavy, are disposed below the first injector unit 36 and the first ejector 38, which are small and light. With this configuration, the center of gravity is lowered, and vibration can be effectively suppressed.

A merging portion 72 is connected to the downstream side of the first ejector 38 and the second ejector 42. The merging portion 72 has a merging path 72a and a bent portion 72b. The merging path 72a extends to encompass the extending direction of the first ejector 38 and the second ejector 42 and is tapered toward the downstream side. That is, the flow path cross-sectional area gradually decreases from a first opening 72d and a second opening 72e toward the bent portion 72b. The bent portion 72b is provided downstream of the merging path 72a, and is bent toward the fuel cell 12. The outlet channel 72c extends from the downstream side of the bent portion 72b toward the inside of the stack case 46.

The jet flow of the first ejector 38 flows into the merging portion 72 through the first opening 72d, and the jet flow of the second ejector 42 flows into the merging portion 72 through the second opening 72e. The first opening 72d is disposed closer to the inner radius of the bent portion 72b, and the second opening 72e is disposed closer to the outer radius of the bent portion 72b.

The fuel gas from the first ejector 38 mainly flows along the inner wall adjacent to the first opening 72d, and bends on the inner radius side (the side with a smaller curvature radius) of the bent portion 72b. The fuel gas from the second ejector 42 mainly flows along the inner wall adjacent to the second opening 72e, and further along the bent portion 72b on the outer radius side (the side with a larger curvature radius). Thus, the fuel gas from the second ejector 42 at a high flow velocity and a high flow volume flows on the outer radius side having a large curvature radius in the bent portion 72b , and thus the pressure loss is reduced.

Even when the fuel gas injection timing of the first ejector 38 and the fuel gas injection timing of the second ejector 42 overlap each other, the flows of the jetted fuel gas can be prevented from colliding with each other inside the merging portion 72, and an increase in pressure loss can be suppressed. Therefore, the fuel gas supply device 24 can suppress variations in the pressure and the flow rate of the fuel gas supplied to the fuel cell 12 due to pressure loss.

The following supplementary notes are further disclosed in relation to the above embodiment.

### Supplementary Note 1

The present disclosure is characterized by the fuel gas supply device (24) configured to supply the high-pressure fuel gas to the fuel cell (12), the fuel gas supply device (24) including the high-pressure pipe (28) through which the high-pressure fuel gas flows, the first injector unit (36) in communication with the high-pressure pipe, the first injector unit being configured to jet out the high-pressure fuel gas at a first flow rate, the first ejector (38) configured to feed an off gas to the fuel cell using a jet flow from the first injector, the second injector unit (40) in communication with the high-pressure pipe, the second injector unit being configured to jet out the high-pressure fuel gas at a second flow rate higher than the first flow rate, and a the second ejector (42) configured to feed the off gas to the fuel cell using a jet flow from the second injector unit, wherein the second ejector is disposed at a position closer to a first axis extending along a center of the high-pressure pipe than the first ejector.

In the fuel gas supply device, the second ejector, which vibrates greatly at the time of ejecting the fuel gas, is disposed close to the first axis of the high-pressure pipe, and thus the vibrations at the time of jetting out the fuel gas can be suppressed. As a result, the fuel gas supply device prevents loosening of the components of the fuel gas supply device due to vibration, and thus has excellent durability.

### Supplementary Note 2

In the fuel gas supply device according to Supplementary Note 1, an angle between the second jetting axis of the second ejector and the first axis may be smaller than an angle between the first jetting axis of the first ejector and the first axis. The fuel gas supply device can suppress vibration at the time of jetting out the fuel gas, and thus has excellent durability.

### Supplementary Note 3

In the fuel gas supply device according to Supplementary Note 2, the second ejector may be disposed below the first ejector. In this fuel gas supply device, the second ejector, which is large and heavy, is disposed on the lower side, and thus the resistance to vibration can be improved so that the durability becomes excellent.

### Supplementary Note 4

The fuel gas supply device according to Supplementary Note 1 may further include the branching portion (34) that connects the high-pressure pipe to the first injector unit and the second injector unit, wherein the second injector unit may be connected to the high-pressure pipe through a path shorter than a path through which the first injector is connected to the high-pressure pipe. In this fuel gas supply device, the second injector unit having a large flow rate and the high-pressure pipe can be connected to each other through a short path, and vibration due to injection of the second injector can be effectively prevented.

### Supplementary Note 5

In the fuel gas supply device according to Supplementary Note 1, the first injector unit may include one injector (44), the second injector unit may include a plurality of injectors, and the second ejector may include the second nozzle (66) configured to merge jet flows from the plurality of injectors. This fuel gas supply device can achieve high output with one type of injectors.

### Supplementary Note 6

In the fuel gas supply device according to Supplementary Note 5, the injector of the first injector unit and at least one of the injectors included in the second injector unit may be arranged in parallel along a straight line. The fuel gas supply device can be made compact because the first injector unit and the second injector unit can be arranged at the shortest distance.

### Supplementary Note 7

In the fuel gas supply device according to Supplementary Note 5, the second nozzle may include the conical flow passage (66a) formed in a conical shape that decreases in diameter with increasing distance from the second injector unit, wherein the plurality of injectors included in the second injector unit may be arranged at equal distance from a second axis extending along a center of the conical flow passage and at equal intervals in a circumferential direction. In this fuel gas supply device, the distances between the merging portion and the respective injectors included in the second injector unit are made equal to each other, and thus it is possible to suppress variations in the flow rate and the flow velocity when the respective injectors are individually operated.

### Supplementary Note 8

In the fuel gas supply device according to Supplementary Note 5, the injector of the first injector unit and the plurality of injectors of the second injector unit may be arranged on the same plane, and all the injectors may be supported by and integrally formed with the first damping plate (54) and the second damping plate (56) which are made of elastic members. The fuel gas supply device can suppress the vibration of each injector at the time of injection by dispersing the vibration, and can prevent the resonance.

### Supplementary Note 9

The present disclosure is characterized in another way by a fuel gas supply device configured to supply a high-pressure fuel gas to a fuel cell, the fuel gas supply device including: a first injector unit configured to jet out high-pressure fuel gas at a first flow rate; a first ejector configured to feed an off gas to the fuel cell using a jet flow from the first injector unit; a second injector unit configured to jet out the high-pressure fuel gas at a second flow rate higher than the first flow rate; a second ejector configured to feed the off gas to the fuel cell using a jet flow from the second injector unit; and the merging portion (72) connected to a downstream side of the first ejector and the second ejector, wherein the merging portion includes the first opening (72d) into which a jet flow from the first ejector flows, the second opening (72e) into which a jet flow from the second ejector flows, the merging path (72a) extending to encompass an extending direction of the first ejector and an extending direction of the second ejector and to allow the fuel gas from the first opening and the fuel gas from the second opening to be merged, and the bent portion (72b) provided downstream of the merging path and bent toward the fuel cell, the first opening being disposed closer to the inner radius of the bent portion, the second opening being disposed closer to the outer radius of the bent portion. The fuel gas supply device can reduce the pressure loss of the gas from the second ejector. Further, even when the injection timing of the first injector and the injection timing of the second injector overlap, collision of the jet flows is prevented, and variations in the pressure and flow rate of the fuel gas supplied to the fuel cell due to the pressure loss can be suppressed.

### Supplementary Note 10

In the fuel gas supply device according to Supplementary Note 9, the flow path cross-sectional area of the merging path may gradually decrease from the first opening and the second opening toward the bent portion. The fuel gas supply device can prevent collision between the jet flow from the first ejector and the jet flow from the second ejector.

### Supplementary Note 11

In the fuel gas supply device according to Supplementary Note 9, the first opening may be located above the second opening.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, these embodiments can also be implemented in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. A fuel gas supply device configured to supply a high-pressure fuel gas to a fuel cell, the fuel gas supply device comprising:
a high-pressure pipe through which the high-pressure fuel gas flows;
a first injector unit in communication with the high-pressure pipe, the first injector unit being configured to jet out the high-pressure fuel gas at a first flow rate;
a first ejector configured to feed an off gas to the fuel cell using a jet flow from the first injector;
a second injector unit in communication with the high-pressure pipe, the second injector unit being configured to jet out the high-pressure fuel gas at a second flow rate higher than the first flow rate; and
a second ejector configured to feed the off gas to the fuel cell using a jet flow from the second injector, wherein
the second ejector is disposed at a position closer to a first axis extending along a center of the high-pressure pipe than the first ejector.

2. The fuel gas supply device according to claim 1, wherein an angle between a second jetting axis of the second ejector and the first axis is smaller than an angle between the first jetting axis of the first ejector and the first axis.

3. The fuel gas supply device according to claim 2, wherein the second ejector is disposed below the first ejector.

4. The fuel gas supply device according to claim 1, further comprising:
a branching portion configured to connect the high-pressure pipe to the first injector unit and the second injector unit, wherein
the second injector unit is connected to the high-pressure pipe through a path shorter than a path through which the first injector is connected to the high-pressure pipe.

5. The fuel gas supply device according to claim 1, wherein
the first injector unit includes one injector,
the second injector unit includes a plurality of injectors, and
the second ejector includes a second nozzle configured to merge jet flows from the plurality of injectors.

6. The fuel gas supply device according to claim 5, wherein the injector of the first injector unit and at least one of the injectors included in the second injector unit are arranged in parallel along a straight line.

7. The fuel gas supply device according to claim 5, wherein
the second nozzle includes a conical flow passage formed in a conical shape that decreases in diameter with increasing distance from the second injector unit, and
the plurality of injectors included in the second injector unit are arranged at equal distance from a second axis extending along a center of the conical flow passage and at equal intervals in a circumferential direction.

8. The fuel gas supply device according to claim 5, wherein
the injector of the first injector unit and the plurality of injectors of the second injector unit are arranged on the same plane, and
all the injectors are supported by and integrally formed with a first damping plate and a second damping plate which are made of elastic members.

9. A fuel gas supply device configured to supply a high-pressure fuel gas to a fuel cell, the fuel gas supply device comprising:
a first injector unit configured to jet out high-pressure fuel gas at a first flow rate;
a first ejector configured to feed an off gas to the fuel cell using a jet flow from the first injector;
a second injector unit configured to jet out the high-pressure fuel gas at a second flow rate higher than the first flow rate;
a second ejector configured to feed the off gas to the fuel cell again using a jet flow from the second injector; and
a merging portion connected to a downstream side of the first ejector and the second ejector, wherein
the merging portion includes:
a first opening into which a jet flow from the first ejector flows;
a second opening into which a jet flow from the second ejector flows;
a merging path extending to encompass an extending direction of the first ejector and an extending direction of the second ejector and to allow the fuel gas from the first opening and the fuel gas from the second opening to be merged; and
a bent portion provided downstream of the merging path and bent toward the fuel cell,
the first opening being disposed closer to an inner radius of the bent portion, the second opening being disposed closer to an outer radius of the bent portion.

10. The fuel gas supply device according to claim 9, wherein
a flow path cross-sectional area of the merging path gradually decreases from the first opening and the second opening toward the bent portion.

11. The fuel gas supply device according to claim 9, wherein the first opening is located above the second opening.
